(19) United States
(12) Patent Application Publication
(10) Pub. No.: US 2018/0255237 A1
(43) Pub. Date: Sep. 6, 2018

(54) METHOD AND APPLICATION FOR AIDING SELF PHOTOGRAPHY

(71) Applicant: Naim SALEM, Nepean (CA)

(72) Inventor: Naim SALEM, Nepean (CA)

(21) Appl. No.: 15/906,326

(22) Filed: Feb. 27, 2018

Related U.S. Application Data
(60) Provisional application No. 62/465,195, filed on Mar. 1, 2017.

(51) Int. Cl. H04N 5/232; G06K 9/62; G06T 7/73

(52) U.S. Cl. CPC H04N 5/23222; H04N 5/23219; G06T 2207/30244; G06K 9/6202; G06T 7/74; H04N 5/23245

(57) ABSTRACT

The present invention provides a method and application for aiding in self photography. A photographer will be able to take photographs on themselves, otherwise known as Selfies, and select a Selfie from these photos that is of particular quality. Once this selection is made, the Selfie photographer may use this template Selfie to replicate additional Selfies. The application will be able to recall and guide the photographer to replicate specific conditions in the template Selfie within a new Selfie. The application may automatically take a new Selfie once the photographer has been guided to a position in which they are able to accurately replicate the specific conditions of the template Selfie.

### FIELD

The present invention pertains to the field of photography and in particular to an aid for self photography.

### BACKGROUND

There has been large growth in the popularity of photography over the last few decades. The onset of digital photography has increased the overall ease of use, accessibility, and management of photography. The popularity increase of photography was also fostered by the emergence of social media platforms and posting digital images on sites such as Facebook™, Twitter™, Instagram™, Tinder™, and others. In particular these social media platforms sparked a grown in the popularity of self photography, also known as and hereafter referred to as a “Selfie”.

Selfies are used in many different ways by the photographer. They can be used recreationally to represent an individual on social media platforms, they can be used within dating profiles to promote the photographer to potential suitors, and they can be used to promote a specific product or service endorsed by the Selfie taker. Achieving high quality and accuracy when taking a Selfie can be very important commercially and personally to the Selfie taker.

Taking a Selfie that is of high quality and accuracy can be difficult. The photographer is forced to manipulate a camera in such a way that the Selfie accurately frames the subject in the picture, accomplishes precise lighting conditions, and generally portrays the subject in a favorable way. Many applications have been developed to help overcome these issues.

Some of the applications that attempt to overcome Selfie issue allow the Selfie-taker to alter the coloring or lighting of the picture by introducing digital filters, or other photograph editing tools. Other applications allow the Selfie-taker the ability to crop the photo, or reposition the subject within the picture.

Consistency in the quality and accuracy of a Selfie can be very important for the commercial and personal success of a Selfie-taker. Achieving a common or consistent “look” or recognizable style may add to the branding potential and marketing success of a Selfie. There are no available Selfie applications that allow the Selfie-taker the ability to recreate multiple Selfies in an accurate and consistent way.

Therefore there is a need for a Selfie aid that allows the photographer to create a Selfie of high quality and accuracy, and that can be recreated consistently by the photographer.

This background information is provided to reveal information believed by the applicant to be of possible relevance to the present invention. No admission is necessarily intended, nor should be construed, that any of the preceding information constitutes prior art against the present invention.

### BRIEF SUMMARY

An object of the present invention is to provide a method for aiding in self photography. In accordance with an aspect of the present invention, there is provided a photographer taking at least one photograph of themselves; the photographer selecting from the at least one photographs, a template photograph of themselves that contains a photograph characteristic of which they wish to replicate; a photograph application utilizing the selected template photograph to analyze the accuracy of replication in photographic conditions between the template photograph and at least one additional photograph of themselves; the photograph application providing guidance to the photographer using the template photograph; the photograph application providing notification to the photographer of the accuracy of replication of a photographic characteristic between the template photograph and the at least one additional photograph; and the photographer taking an additional photograph of themselves based upon the guidance provided by the photograph application.

In accordance with another aspect of the present invention, there is provided application for aiding in self photography comprising a microprocessor, a memory, a data storage database, a photography module and a communication interface, configured to enable a photographer to select a template photograph; enable a photographer to make selections regarding the characteristics of the template photograph; enable a photographer to store information about selections they have made; utilize a photographer selected template photograph to guide a photographer in taking at least one additional photograph; utilize a photographer selection regarding the characteristics of the template photograph to guide a photographer in taking at least one additional photograph; and provide notification to the photographer of a similar characteristic between the template photograph and the at least one additional photograph.

In accordance with one aspect of the present invention, the method and applications may be used with any camera in the device including the front and back cameras.

### BRIEF DESCRIPTION OF THE FIGURES

Embodiments of the present invention will be better understood in connection with the following Figures, in which:

FIG. 1 illustrates a flowchart of the general steps in the method for aiding in self photography; and

FIG. 2 illustrates a flowchart of how the application communication interface may guide and notify an application user in order to aid the user in self photography.

### DETAILED DESCRIPTION

### Definitions

The term “application user” is used to define an individual, corporation, association, group, or other entity as would be understood by someone skilled in the art, which uses the method and application for aiding in self photography. The terms “application user” and “photographer” are used interchangeably.

### Method and Application Overview

The present invention provides a method for aiding in self photography for a photographer who wishes to take a photograph of them self, and repeat the characteristics of that photograph in an additional photograph. The photographer will select a photograph to use as a template photograph, which contains a photographic characteristic of which the photographer wishes to replicate. The photograph application will then use the selected template photograph to guide the photographer in taking an additional photograph of them self. The photograph application will also provide notification to the photographer when the similar characteristic of the template photograph has been replicated in the additional photograph. Once this is achieved the photographer may take the additional photograph of themselves.

The present invention also provides an application for aiding in self photography utilizing a microprocessor, a memory, a data storage database, a photography module and a communication interface. The photography module and communication interface will enable a photographer to select a template photograph and make selections regarding the photographic characteristics of the template photograph. The data storage database enables the photographer to store information about selections they have made. The communication interface will use a photographer selected template photograph to guide a photographer in taking an additional photograph. The photograph module will analyze the photographer selections regarding the characteristics of the template photograph to help the communication interface guide the photographer in taking an additional photograph. The communication interface will also provide notification to the photographer once the similar characteristics between the template photograph and the additional photograph have been achieved.

In one embodiment the application may be accessed upon a personal computer, personal communication device, tablet, smart phone, digital camera, or other apparatus capable of taking a photograph as would be understood by someone skilled in the art.

In one embodiment the photographer may take a photograph of themselves, also known as a Selfie. It is also contemplated that the photographer may take a photograph of another subject as would be understood by someone skilled in the art.

In another embodiment the application is capable of taking a photograph that does not require an aid for self photography. The application is also capable of importing digital photographs from other sources/location, which were not taken using the application.

In one embodiment the photographer may use the application to replicate a photographic characteristic such as but not limited to subject orientation, subject location, lighting, colouring, composition, perspective, zoom, clarity, or otherwise as would be understood by someone skilled in the art, within an additional photograph.

In one embodiment the application will be provided for a one-time fee to application users. In another embodiment additional application functionality and/or capabilities may be made available to an application user for additional fees. It is also contemplated that the application will impose fees upon an application user based on per-photo use.

### Photograph Module

In one embodiment the photograph module (hereinafter also referred to as “PM”) will analyze a photographer's selections regarding the photographic characteristics of a template photograph. The template photograph may be taken within the application, or may be imported into the application. The photographic characteristic selections may be made manually by the photographer, or may be automatically selected by the PM.

In one embodiment the PM will analyze photograph characteristics corresponding to the physical positioning of the subject within the template photograph. The PM may analyze details such as but not limited to subject distance from lens, body positioning of subject, position and dimensions of the subject face and/or body, orientation of camera, and other details as would be understood by someone skilled in the art. The PM may then use these details to assess the positioning of the subject within the impending additional photograph, and provide information to the communication interface (hereinafter also referred to as “CI”) that will direct the photographer on how to alter the position of the camera. This analysis will continue until the subject positioning within a template photograph is accurately replicated in the impending additional photograph. Once this replication is complete, the PM will interact with the CI to communicate that replication of subject positioning within the impending additional photograph is complete, and the photographer may then take an additional photograph.

In another embodiment the PM will analyze camera orientation characteristics corresponding to the physical positioning of the camera when taking a template photograph. The PM may use these details to assess the positioning of the camera when attempting to take an impending additional photograph, and provide information to the CI that will direct the photographer in order to alter the position of the camera. This analysis will continue until the camera positioning when taking a template photograph is accurately replicated in the camera positioning when taking an impending additional photograph. Once this replication is complete, the PM will interact with the CI to communicate that replication of camera positioning is complete, and the photographer may then take the additional photograph.

In another embodiment the PM will analyze photograph background characteristics corresponding to the photograph background of a template photograph. The PM may use these details to assess the photograph background when attempting to take an impending additional photograph, and provide information to the CI that will direct the photographer. This analysis will continue until the photograph background characteristics of a template photograph are accurately replicated in the photograph background characteristics of an impending additional photograph. Once this replication is complete, the PM will interact with the CI to communicate that replication of photograph background characteristics are complete, and the photographer may then take the additional photograph.

In another embodiment once the PM has completed analysis of photographic characteristics, and template photographic characteristics have been accurately replicated within an impending additional photograph, the PM may automatically take an additional photograph.

In another embodiment the photographer may be able to select a photographic characteristic tolerance. This tolerance may be used by the PM when assessing the accuracy of replication between the template photograph and the additional photograph. If the photographic characteristics of a template photograph are replicated in an additional photograph within the tolerance, the PM may automatically take an additional photograph. The photographic characteristic tolerance may also be automatically generated and used by the PM without input from the photographer.

In one embodiment the photographer will be able to save details related to photographic characteristic selections. The photographer may then access these saved details and request that the PM use these saved details to perform photographic characteristic analysis.

In an additional embodiment the PM will provide other photograph editing capabilities as would be understood by someone skilled in the art.

In another embodiment the PM will provide an application user with the ability to upload an additional photograph to an alternative digital platform such as but not limited to Instagram™, Facebook™, Twitter™, Tinder™, or other digital platforms capable of supporting digital photography as would be understood by someone skilled in the art.

In one embodiment the PM will allow a photographer to take unaltered photographs that do not utilize the method and application for aiding in self photography. The PM will provide a photographer the ability to take photographs as would be understood by someone skilled in the art. The CI will then provide the application user the ability to view these unaltered photographs and make selections regarding these photographs. For example, the application user may take a series of unaltered photographs, view those photographs and select the unaltered photograph they like best of the series, to be used as a template photograph.

### Communication Interface

In one embodiment the CI will communicate with the application user in order to guide the photographer. The CI will guide the photographer so that photographic characteristics of a template photograph can be replicated in an additional photograph.

In one embodiment the CI will guide the photographer using a colour guide when a photographer wishes to replicate a template Selfie. The colour guide will illustrate to the photographer which angle and distance the camera should be in order to replicate the Selfie. As the photographer changes the orientation of the camera, which could be located within a smart phone, numbers related to this orientation will modify and be communicated to the photographer. The CI will display the colour red when the template photographic conditions are distant from being replicated within an impending additional photograph. As the template photographic conditions get closer to being replicated within the impending addition photograph, the colour yellow will be displayed. Once the template photographic conditions accurately replicate those within the impending addition photograph, the CI will display the colour green. Once the CI displays green, the additional photograph may be automatically taken.

In another embodiment the colour guide may use different shades of colour to signify degrees of similarity between the template photograph and the impending additional photograph. The shades of colour may provide additional guidance to the photographer. For example, if shades of yellow gradually fade into shades of green as the photographer orients a camera closer to a position that accurately replicates a template photographic characteristic within an impending additional photograph, the photographer will be able to use these colour indications to help guide them in orienting their camera.

In another embodiment the CI will guide the photographer using guiding means such as but not limited to audio guidance such as beeping, visual guidance, numerical guidance, written guidance, tactile guidance, or another guidance means as would be understood by someone skilled in the art.

In one embodiment the CI will allow an application user to connect with alternative digital platforms. The application user may make selections about posting, editing, and commenting on photographs to these alternative digital platforms using the CI. The application user may import photographs from alternative digital platforms to be used within the application as a template photograph.

In another embodiment the CI will allow an application user to access photographs stored upon a user's personal computing device, tablet, camera, smart phone, or other device capable of storing photographs, in order to use these photographs within the application as a template photograph. The application will also allow the user to import photographs stored in alternative locations, for example within a cloud storage space, or upon an external storage device, for the purposes of use as a template photograph.

### Data Storage Database

In one embodiment the data storage database (hereafter also referred to as “DSD”) will store information related to the application. The DSD may store information such as but not limited to application user data, preferences, selections, and history, digital photographs, photographic characteristic selections, photograph location, GPS information, and otherwise as would be understood by someone skilled in the art.

In another embodiment the DSD will stores information related to the template photographs selected by the application user. The DSD may store and organize template photographs in relation to the template photograph date and time of use within the application, or by some other organizational method as understood by someone skilled in the art.

The invention will now be described with reference to specific examples. It will be understood that the following examples are intended to describe embodiments of the invention and are not intended to limit the invention in any way.

### EXAMPLES

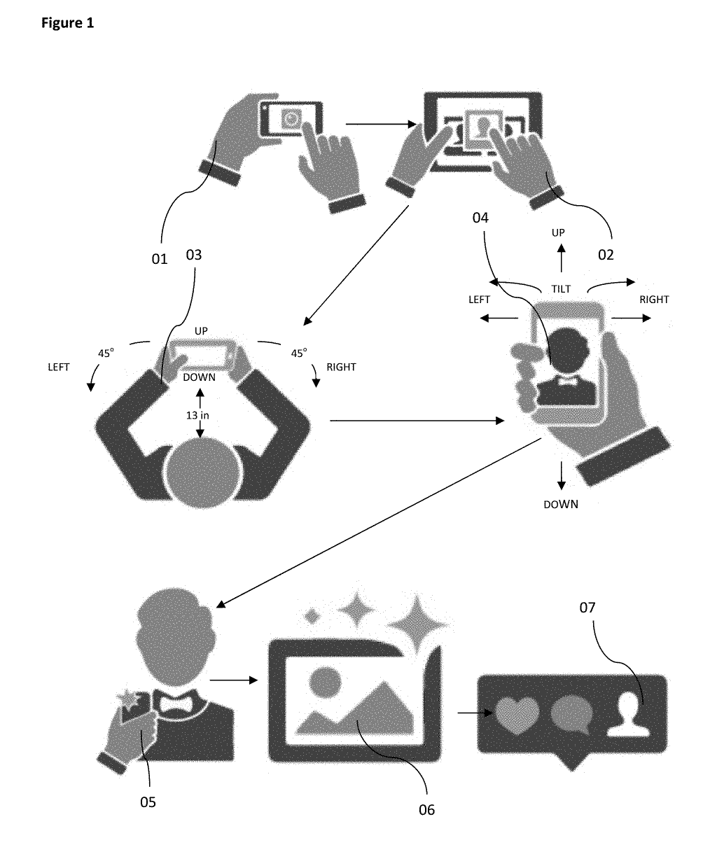

In one embodiment as described in FIG. 1, the application user will take multiple Selfies using their smart phone 01. The application user will then browse through the Selfies and select a Selfie template photograph 02 from the Selfies they have taken. The application user may then select photographic characteristics related to their orientation within the Selfie template photograph 03 that they wish to replicate in an impending Selfie additional photograph. The application will then guide the user 04 in order to aid the photographer to position themselves within the Selfie additional photograph in the same way they are positioned within the Selfie template photograph. Once the positioning of the photographer within the Selfie template photograph is accurately replicated within the Selfie additional photograph, the application will automatically take the Selfie additional photograph 05. Once the Selfie additional photograph has been taken, the photographer may make additional changes to the photograph 06 such as applying photographic filters until the Selfie additional photograph has been edited to an acceptable state as determined by the photographer. Finally the photographer may then share the edited Selfie additional photograph on another social media platform 07.

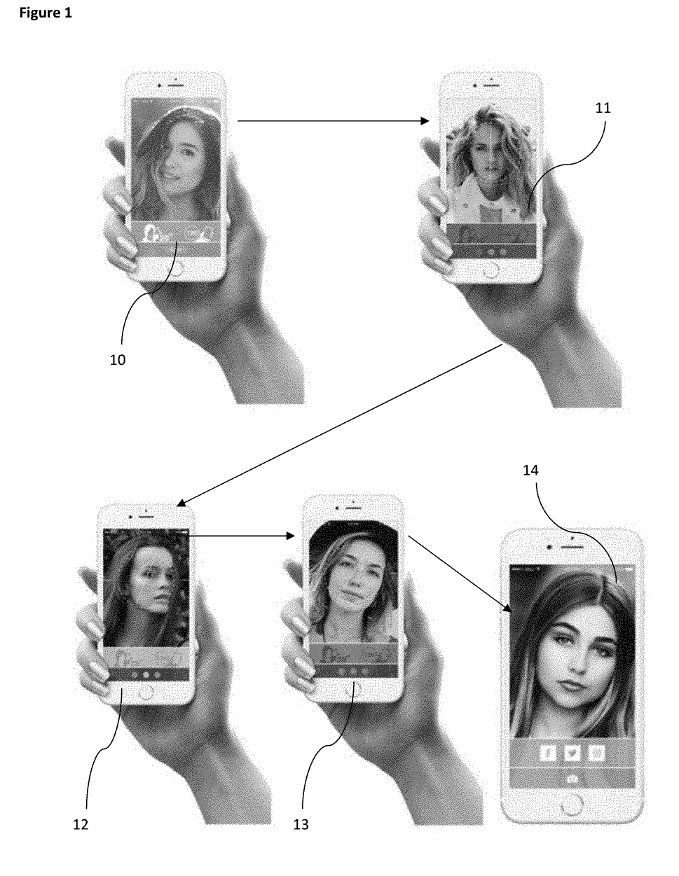

In one embodiment as described in FIG. 2, the application user selects a Selfie template photograph 10 that they wish to replicate in a Selfie additional photograph. The application will then assess the orientation of a smart phone in relation to the photographer and indicate that the positioning of the phone is largely inaccurate 11 for replication of the Selfie template photograph position of the photographer within an impending Selfie additional photograph—the application will display red in order to communicate this inaccuracy. As the photographer alters the orientation of the smart phone to more closely replicate Selfie template photograph conditions within an impending Selfie additional photograph 12, the application will display yellow. Once the photographer alters the orientation of the smart phone to accurately replicate Selfie template photograph conditions within an impending Selfie additional photograph 13, the application will display green. Once the orientation of the smart phone accurately replicates Selfie template photograph conditions within an impending Selfie additional photograph, the application will also automatically take a Selfie additional photograph 14.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure some or all of its components in accordance with the system of the invention.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, personal communication device, server, PDA, or the like and pursuant to one or more, or a part of one or more, program elements, modules or objects generated from any programming language, for example but not limited to languages such as C++, Java, PL/1, or the like. In addition, each step, or a file or object or the like implementing each said step, may be executed by special purpose hardware or a circuit module designed for that purpose.

The scope of the claims should not be limited by the preferred embodiments set forth in the examples, but should be given the broadest interpretation consistent with the description as a whole.

We claim:

1. A method for aiding in self photography comprising:
a photographer taking at least one photograph of themselves;
the photographer selecting from the at least one photographs, a template photograph of themselves that contains a photograph characteristic of which they wish to replicate;
a photograph application utilizing the selected template photograph to analyze the accuracy of replication in photographic conditions between the template photograph and at least one additional photograph of themselves;
the photograph application providing guidance to the photographer using the template photograph;
the photograph application providing notification to the photographer of the accuracy of replication of a photographic characteristic between the template photograph and the at least one additional photograph; and
the photographer taking an additional photograph of themselves based upon the guidance provided by the photograph application.

2. method for aiding in self photography according to claim 1, wherein the photograph characteristic of which the photographer wishes to replicate is the physical positioning of the photographer within the photograph.

3. The method for aiding in self photography according to claim 1, wherein the photograph application guidance will aid the photographer in positioning a camera in such a way that it replicates the position of the photographer within the additional photograph to that of the position of the photographer within the template photograph.

4. The method for aiding in self photography according to claim 1, wherein the photograph application will automatically take a photograph once the photograph characteristic of the template photograph has been replicated by the photographer.

5. A method for aiding in photography comprising:
a photographer taking at least one photographs;
the photographer selecting from the at least one photographs a template photograph that contains a photograph characteristic of which they wish to replicate;
a photograph application utilizing the selected template photograph to analyze the accuracy of replication in photographic conditions between the template photograph and at least one additional photograph;
the photograph application providing guidance to the photographer using the template photograph;
the photograph application providing notification to the photographer of the accuracy of replication of a photographic characteristic between the template photograph and the at least one additional photograph; and
the photographer taking an additional photograph based upon the guidance provided by the photograph application.

6. The method for aiding in photography according to claim 5, wherein the photograph application will automatically take a photograph once the photograph characteristic of the template photograph has been replicated by the photographer.

7. A photograph application for aiding in self photography comprising a microprocessor, a memory, a data storage database, a photography module and a communication interface and configured to:
enable a photographer to select a template photograph;
enable a photographer to make selections regarding the characteristics of the template photograph;
enable a photographer to store information about selections they have made;
utilize a photographer selected template photograph to guide a photographer in taking at least one additional photograph;
utilize a photographer selection regarding the characteristics of the template photograph to guide a photographer in taking at least one additional photograph; and
provide notification to the photographer of a similar characteristic between the template photograph and the at least one additional photograph.

8. The photograph application of claim 7, wherein the application is configured for use with any camera in the photographer's device, optional the front camera and back camera.
